(19) United States
(12) Patent Application Publication
(10) Pub. No.: US 2014/0087343 A1
(43) Pub. Date: Mar. 27, 2014

(54) AUSCULTATION TRAINING DEVICE AND RELATED METHODS

(71) Applicant: Paul Jacques Charles Lecat, Tallmadge, OH (US)

(72) Inventor: Paul Jacques Charles Lecat, Tallmadge, OH (US)

(21) Appl. No.: 14/094,908

(22) Filed: Dec. 3, 2013

Related U.S. Application Data
(63) Continuation-in-part of application No. 13/755,996, filed on Jan. 31, 2013.
(60) Provisional application No. 61/592,628, filed on Jan. 31, 2012.

(51) Int. Cl. G09B 23/28

(52) U.S. Cl. CPC G09B 23/28
USPC 434/266

(57) ABSTRACT

An auscultation system is disclosed herein. The auscultation system includes an auscultation device. The auscultation system also includes a proximity device operable to detect the proximity of the auscultation device. The proximity device can also emit a signal in response to detection of the auscultation device. The auscultation system also includes a first database storing a plurality of sound files. The auscultation system also includes a first controller operable to communicate with the proximity device and receive the signal. The first controller is also operable to select one of the sound files and transmit the selected sound file to the at least one speaker in response to receipt of the signal from the proximity device.

### CROSS-REFERENCE TO RELATED APPLICATIONS

This application is a continuation-in-part of U.S. patent application Ser. No. 13/755,996 for an AUSCULTATION TRAINING DEVICE AND RELATED METHODS, filed on Jan. 31, 2013, and also claims the benefit of U.S. Provisional Patent Application Ser. No. 61/592,628 for an AUSCULTATION TRAINING DEVICE AND RELATED METHODS, filed on Jan. 31, 2012, which are both hereby incorporated by reference in its entireties.

### BACKGROUND OF THE INVENTION

1. Field of the Invention

The invention relates to devices, methods, and systems relating to auscultation training.

2. Description of Related Prior Art

Auscultation is the act of listening to sounds within the body as a method of diagnosis. A stethoscope is an example of an auscultation device that is used in the medical field to listen to internal sounds in the human body, such as for example heart sounds, breathing (breath sounds), intestinal noises, and blood flow in arteries and veins. Acoustic stethoscopes operate on the transmission of sound from a headpiece, via air-filled hollow tubes, to a listener's ears. The headpiece may include a diaphragm that can be placed against a human body for sensing sound. Body sounds vibrate the diaphragm, creating acoustic pressure waves that travel through the tubing to the listener's ears.

Using a stethoscope or other auscultation device to diagnose a patient requires training in detecting and identifying abnormal sounds. Standardized patients are a valuable training tool in medical education and have been extensively researched. Though standardized patients give students one-on-one interaction with real human subjects, most standardized patients do not present abnormal symptoms. As a result, simulators and mannequins are often used to train or test students on auscultation devices, such as stethoscopes. Auscultation training mannequins may include a sound generating device embedded within the body of the mannequin to produce sounds consistent with an abnormal physical condition, which students must detect and identify.

### SUMMARY OF THE INVENTION

In summary, the invention is an auscultation system. The auscultation system includes an auscultation device. The auscultation system also includes a proximity device operable to detect the proximity of the auscultation device. The proximity device can also emit a signal in response to detection of the auscultation device. The auscultation system also includes a first database storing a plurality of sound files. The auscultation system also includes a first controller operable to communicate with the proximity device and receive the signal. The first controller is also operable to select one of the sound files and transmit the selected sound file to the at least one speaker in response to receipt of the signal from the proximity device.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 a schematic diagram showing an embodiment of the invention;

FIG. 2 shows a second embodiment of the invention;

FIG. 3 shows a third embodiment of the invention;

FIG. 4 shows a fourth embodiment of the invention; and

FIG. 5 shows a fifth embodiment of the invention.

### DETAILED DESCRIPTION OF EXEMPLARY EMBODIMENT

A plurality of different embodiments of the invention is shown in the Figures of the application. Similar features are shown in the various embodiments of the invention. Similar features have been numbered with a common reference numeral and have been differentiated by an alphabetic suffix. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The present invention generally relates to systems for auscultation training and methods associated with such systems. Auscultation mannequins incorporating speakers are known, such as disclosed in U.S. Pat. No. 3,564,729. Embodiments of the invention can be practiced as a kit which modifies the operation of existing auscultation mannequins incorporating speakers. Speakers in mannequins, such as speakers 21 shown in U.S. Pat. No. 3,564,729, can receive signals corresponding to sounds through a hard wire connection or wirelessly. A controller would control the transmission of signals to the speakers.

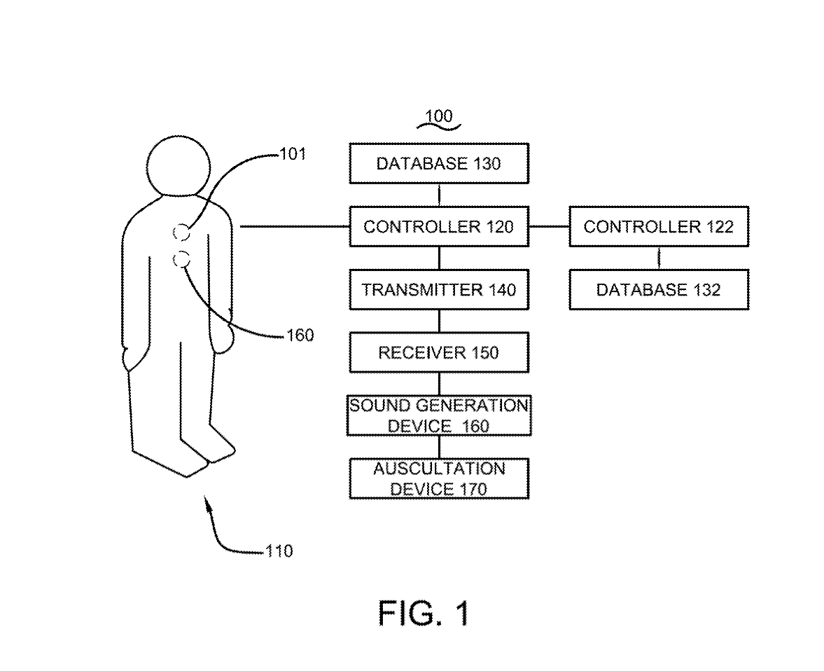

FIG. 1 is a schematic diagram showing an embodiment 100 of the invention. The embodiment 100 includes a mannequin 110 fitted with at least one proximity sensor 101 for detecting the relative position of an auscultation device 170. The proximity sensor 101, shown in dash line since it is embedded within the mannequin 110, communicates proximity data to a controller 120.

Controller 120 determines the position of the auscultation device 170 relative to mannequin 110, and thus determines which sound, or class of sounds, is appropriate for transmission. For example, if the auscultation device 170 is found to be proximal to a heart region, an appropriate sound may be one or more heart sounds. Accordingly, controller 120 selects an appropriate sound file from database 130 and retrieves the selected sound file. The controller 120 then communicates the sound file to a transmitter 140, which wirelessly broadcasts the sound file according to a predetermined protocol. The broadcast signal is received by receiver 150 and communicated to a sound generation device 160, such as a speaker embedded in the mannequin 110 or speaker not embedded in the mannequin 110. The sound generation device 160 may be located on the auscultation device 170. The sound generation device 160 communicates an acoustic wave through an auscultation device 170, which audibly delivers the acoustic wave to a listener. It is noted that sounds that are generated could be synchronized with the EKG, breathing, pulses, and any of the other mannequin functions.

In an embodiment of the invention, an additional controller 122 can be included to override previously implemented control logic applied by the controller 120. Thus, an embodiment of the invention can define an after-market modification or kit to an existing auscultation mannequin 110 that incorporates speakers 160 and is controlled by a controller 120. An embodiment of the invention can include the controller 122 which is operable to modify the logic and/or code of the controller 120. As a result, an embodiment of the invention can bypass the “native system” of an existing auscultation mannequin 110. A basis for bypassing the native system can be a break-down of the native system or if it is desired to emit new, different sounds than the mannequin 110 could previously generate.

The controller 122 can control the controller 120 in several different ways in one or more embodiments of the invention. The controller 122 can control the controller 120 to deviate from prior programming to play a sound different from the sound called for by original programming. The controller 122 can also control the controller 120 to search for sound files in a database different from the previously-existing database 130, such as database 132. The controller 120 can communicate directly with the database 132 or can communicate with the database 132 through the controller 122. The controller 122 can also control the controller 120 to transfer sound files from the database 132 and store those files in the database 130.

It is noted that after an embodiment of the invention has been operated, the sound generating devices 160 can again be controlled by the original controller 120. Embodiments of the invention will not destructively engage the existing system such that the device cannot return to its original condition.

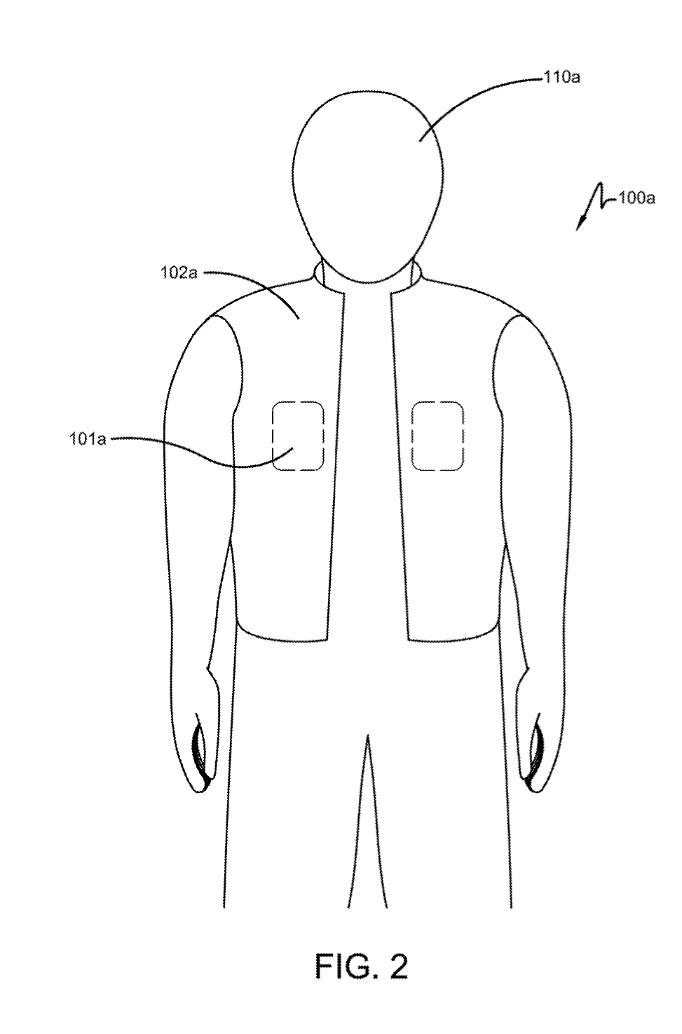

FIG. 2 shows an alternative embodiment 100a. A mannequin 110a is shown wearing a vest 102a. A proximity sensor 101a is mounted on and/or embedded within the vest 102a. The vest 102a is thus an article of clothing that may also be worn by a live human. A sound generating device may be embedded within the vest 102a in some embodiments of the invention. In other embodiments of the invention, a sensor could be mounted with respect to any other article of clothing, such as a sock, pants, hats, mitten, or gloves.

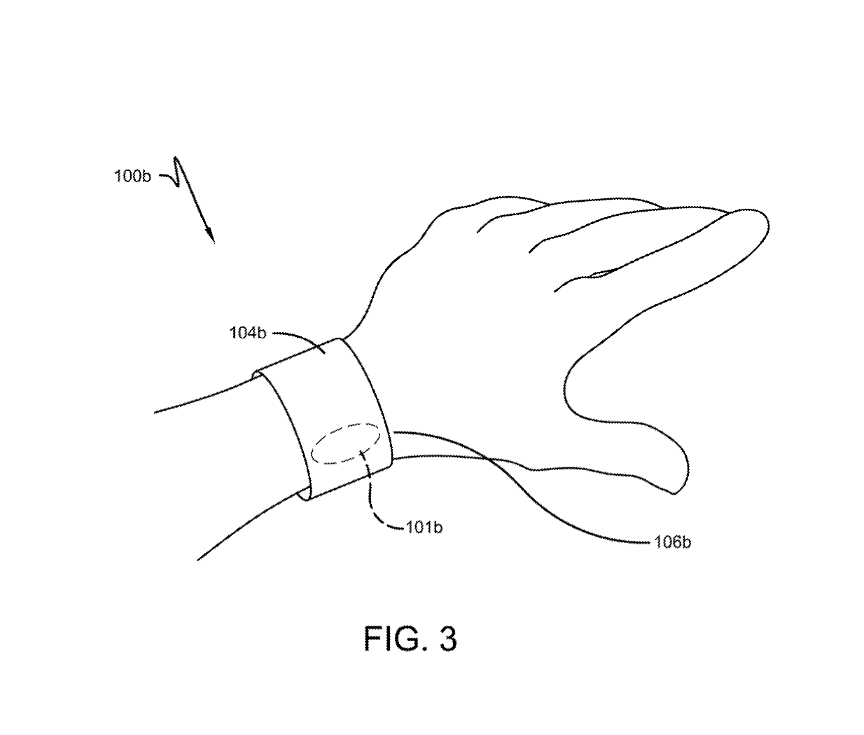

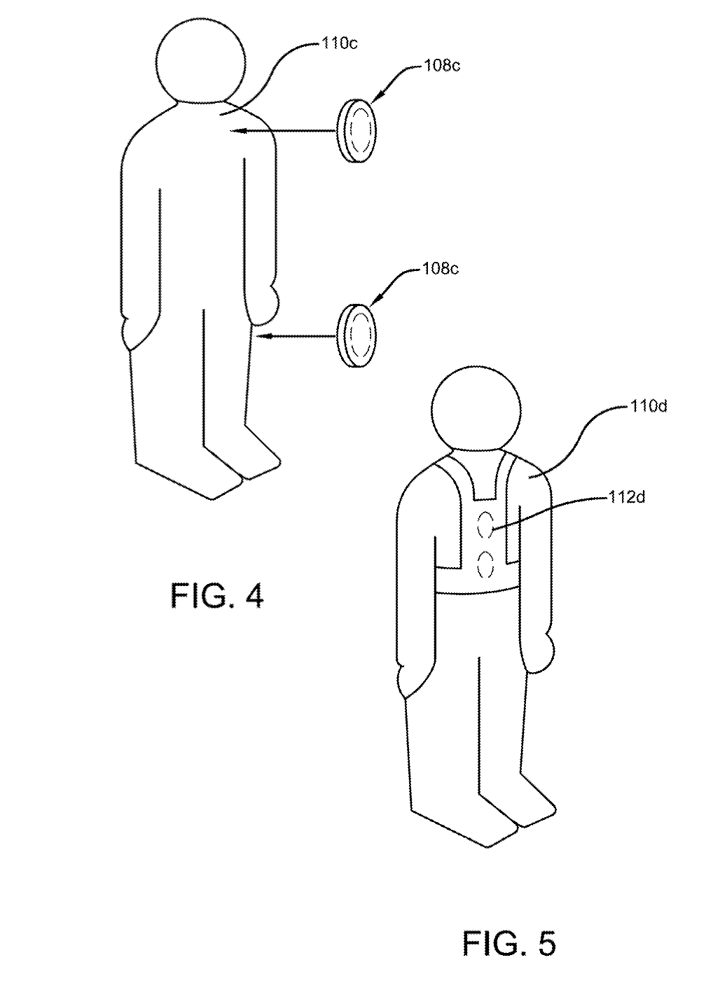

FIG. 3 shows another alternative embodiment 100b. A strap or sleeve or band 104b can support a proximity sensor 101b. The band 104b can be worn on a human wrist 106b or on the wrist of a mannequin. The vest 102a and the band 104b define alternative mounting structures that may be attached, secured, affixed, or mounted on a human subject or a mannequin. The sound generating device 160 may be embedded within such a mounting structure. In various embodiments, the mounting structure could take other forms such as an adhesive sheet, a harness, or a tether. FIG. 4 shows a plurality of adhesive sheets or patches 108c, each supporting a proximity sensor (in dash line) being mounted on a mannequin 110c. FIG. 5 shows a harness 112d mounted on a mannequin 110d and supporting a plurality of proximity sensors (in dash line).

It is also noted that the embodiments of the invention described above can be practiced with a ventriloscope, as set forth in U.S. Pub. No. 2009/0117527. The ventriloscope receiver could have an output jack to a speaker or recording device.

It is also noted position detection can be achieved in various ways in embodiments of the broader invention. Approaches that can be applied include, but are not limited to, capacitive, inductive, magnetic, passive-optical, barcode, infrared, photocell, radar, sonar, ultrasonic, RFID, laser, Eddy-current, or Doppler effect.

It is also noted that any of a wide variety of wireless communications means can be appropriate for data and/or control signal transmission. For instance, some appropriate means can include radio or infrared communications means. More specifically, some appropriate protocols include, without limitation WiFi, Bluetooth® (Bluetooth is a registered certification mark of Bluetooth Sig Inc., Bellevue, Wash.), ZigBee® (ZigBee is a registered trademark of ZigBee Alliance Corp., San Ramon, Calif.) and the like. Similarly, any of a wide range of hardwired connections can be appropriate. Some such connections include, without limitation, serial bus, parallel bus, SCSI, I2C (inter-integrated circuit), SPI (serial peripheral interface), and the like or any combination thereof. One of skill in the art will recognize that a wide range of wireless and hardwire technologies are available, and will be able to select an appropriate technology without undue experimentation.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Further, the “invention” as that term is used in this document is what is claimed in the claims of this document. The right to claim elements and/or sub-combinations that are disclosed herein as other inventions in other patent documents is hereby unconditionally reserved.

What is claimed is:

1. An auscultation training system comprising:
an auscultation device;
a proximity device operable to detect the proximity of said auscultation device and emit a signal in response to detection of said auscultation device;
a first database storing a first plurality of sound files; and
a first controller operable to communicate with said proximity device and receive the signal and select one of said sound files and transmit said one of said sound files to said at least one speaker in response to receipt of the signal.

2. The auscultation training system of claim 1 further comprising:
a mounting structure supporting said proximity device and operable to position said proximity device on at least one of a mannequin and a human subject.

3. The auscultation training system of claim 2 wherein said mounting structure is further defined as being releasibly engageable with the at least one of a mannequin and a human subject.

4. The auscultation training system of claim 2 wherein mounting structure is further defined as an adhesive pad.

5. The auscultation training system of claim 2 wherein mounting structure is further defined as a vest.

6. The auscultation training system of claim 2 wherein mounting structure is further defined as a harness.

7. The auscultation training system of claim 2 wherein mounting structure is further defined as a band.

8. The auscultation training system of claim 1 further comprising:
a second controller operable to override said first controller.

9. The auscultation training system of claim 8 further comprising:
a second database storing a second plurality of sound files.

10. The auscultation training system of claim 9 wherein said first controller is operable to select one or more sound files from either of said first and second databases.

11. The auscultation training system of claim 10 wherein said second controller is operable to control said first controller in selecting which of said first and second databases to access for a sound file.
